(19) United States
(12) Patent Application Publication
(10) Pub. No.: US 2003/0130867 A1
(43) Pub. Date: Jul. 10, 2003

(54) Consent system for accessing health information

(76) Inventors: Rohan Coelho, Portland, OR (US); Michael J. Payne, Beaverton, OR (US); Robert Adams, Portland, OR (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/038,933

(22) Filed: Jan. 4, 2002

(51) Int. Cl. G06F 17/60; G06F 15/16

(52) U.S. Cl. 705/2; 709/217

(57) ABSTRACT

The present invention provides for controlling health information retrieval by monitoring consent afforded for a requested disclosure through a real-time network pathway. An access server is provided within a user system that receives requests for the health information generated from a portable healthcare device. The access server determines whether a corresponding consent has been provided by an authorization holder, and permits the health information to be accessed if the consent is found. When health information may be provided in response to the request, the access server communicates with a remote site that immediately processes the request and transmits the health information. In addition, other aspects of the present invention relate to the processing of requests for health information and monitoring of consent.

### FIELD OF THE INVENTION

The present invention relates generally to controlling access to health information from across a network. In particular, this invention is related to determining the existence of consent for receipt of health information from across a network.

### BACKGROUND

There are growing uses for handheld devices in conducting health-related transactions that involve exchanges of electronic information across a network. Health professionals, such as physicians, medical staff, dentists, chiropractors, physical therapists, pharmacists, clinical trial specialists, biomedical researchers, health plan administrators, public health officials, etc., may use handheld devices in performing their daily workflow. Many of these tasks, such as writing prescriptions, checking laboratory results, dictating information and capturing charges are best performed as a patient is being cared for, i.e. at the point of care. However, real-time performance of these tasks is often not feasible with current communication systems because several parties must participate in the transactions. In addition, immediate transactions often require concurrent communication with and access to health information that is kept at a site located across a network. Present health communication systems do not provide convenient interaction between handheld devices and such remote sites on a real-time basis.

There are numerous health-related transactions that may involve remote sites, which may be facilitated by use of a handheld device. For example, the handheld device may be used for “eprescribing” services to submit online claims to remote payers and to electronically route orders to pharmacies, including retail, online or mail order pharmacies. E-prescribing enables a health professional to write, order and renew prescriptions and to review information related to selected drugs. E-prescribing may reduce callbacks from patients and pharmacists, as well as decrease medical errors caused by illegible handwriting or adverse drug interactions.

The use of a handheld device to write prescriptions may also be advantageous for Pharmacy Benefit Managers (PBM's), which remotely manage the process of health insurance companies paying for prescriptions. Health information exchanged through the use of handheld devices may result in increase formulary compliance, resulting in PBM's receiving higher margins for filling drugs based on formularies. In addition, there may be improved drug compliance where prescription history information, such as whether a patient had filled a new prescription and whether a patient had received a refill within the prescribed time, is transferred.

Testing laboratories may also benefit from handheld devices used in electronic transactions related to lab services, i.e. e-lab services. There may be cost savings in being able to electronically receive orders for tests and send laboratory results. A health professional may use the device to write, modify and order laboratory tests, view test results, review information related to the selection of a laboratory test, etc.

Many of these tasks and access to health information must be coupled with a properly obtained consent. One impediment in health systems communicating with remote sites is a growing level of trepidation about maintaining privacy in health information connected with electronic information exchange. The need for privacy of health information has long been recognized as critical to the delivery of medical care.

Many remote sites that retain health information, such as health planners, providers, and clearinghouses have taken steps to safeguard the privacy of sensitive health information. In addition, some government regulations including federal and state laws, limit non-consensual use and release of private health information.^{1,2} Improper use or disclosure of personal health information may result in criminal and/or civil sanctions. ¹ One example of U.S. federal government regulations are set forth in 45 CFR Parts 160 through 164, “Standards for Privacy of Individually Identifiable Health Information” (2001) issued by the Department of Health and Human Services (DHHS) in response to the Health Insurance Portability and Accountability Act of 1996 (HIPPA) due to Congress failing to enact medical record privacy standards by Aug. 21, 1999. ² Other examples of U.S. regulations that govern Medicare providers, such as the Privacy Act of 1974; substance abuse treatment facilities, such as Substance Abuse Confidentiality provisions of the Public Health Service Act, section 543; and health care providers in schools, colleges, and universities within the purview of the Family Educational Rights and Privacy Act.

With current systems, data is usually transferred to a computer, such as through a docking system, and the submission is transferred to the appropriate responding entity after a period of time according to its place in a queue. Further delays may arise at the remote information site for the request to be processed or at any other intermediary segment along the way. In addition, where it is necessary to determine whether consent has been provided, this added step may extend the lag time. Moreover, where consent must be acquired, significant holdup may result. Consequently, there exists considerable postponement in providing health services.

In general, the shortcomings of the currently available methods for performing electronic health transactions are inadequate for retrieving health information in real-time from a network. In particular, previous methods do not conveniently permit immediate tracking of consent for retrieval of health information from a remote site across a network.

### BRIEF DESCRIPTION OF THE DRAWINGS

The present invention is illustrated by way of example, and not limitation, in the figures of the accompanying drawings in which:

FIG. 1 is a block diagram illustrating one embodiment of a health information system having a user system that communicates with one or more remote sites, in accordance with the teachings presented herein.

FIG. 2 is a block diagram example of a portable healthcare device to request health information, in accordance with the teachings presented herein.

FIG. 3 is a block diagram example of an access server to process requests from the portable healthcare device, in accordance with the teachings presented herein.

FIG. 4 is an illustration of an exemplary consent database for storing consent related data, according to teachings presented herein.

FIG. 5 is a block diagram depicting the transferring of payload data across a real-time network pathway, according to teachings presented herein.

FIGS. 6A and 6B are flow charts depicting methods for controlling access to health information by an access server, in accordance with the teachings presented herein.

FIG. 7 is a block diagram of a machine-accessible medium storing executable code and/or other data to provide one or a combination of mechanisms to control retrieval of health information, in accordance with one embodiment of the present invention.

### DETAILED DESCRIPTION

The present invention provides a communication system that includes a real-time communication channel between a portable healthcare device, e.g. wireless handheld device, and a remote information site. The system also enables an access server to control health information retrieval by monitoring consent afforded for a requested disclosure. The access server may obtain from the portable healthcare device, a request for a user to receive specific health information from a remote site across a network. Health information is information related to a subject's health, well-being, or makeup. The subject may be a person, entity or animal. A user that may receive the health information may be any health professional, such as a healthcare provider, e.g. a provider of medical or health-related services and any other person or organization that furnishes, bills, or is paid for healthcare services or supplies in the normal course of business.

The access server is to determine if the user is permitted to gain access to the health information based on whether a corresponding consent, if required, has been provided by an authorization holder, e.g. patient. Where a corresponding consent had been previously obtained, the access server may immediately permit the health information to be relayed to the user. If consent is required but not located by the access server, the access server may withhold the information and optionally notify the user of the lack of consent. In this manner, health information can be instantly acquired from a remote site within the limits permitted for such a disclosure. The request is transferred through the network and processed in real-time, a user may access information close to real-time, e.g. within a few seconds or less of submitting the request, and in compliance with privacy restrictions.

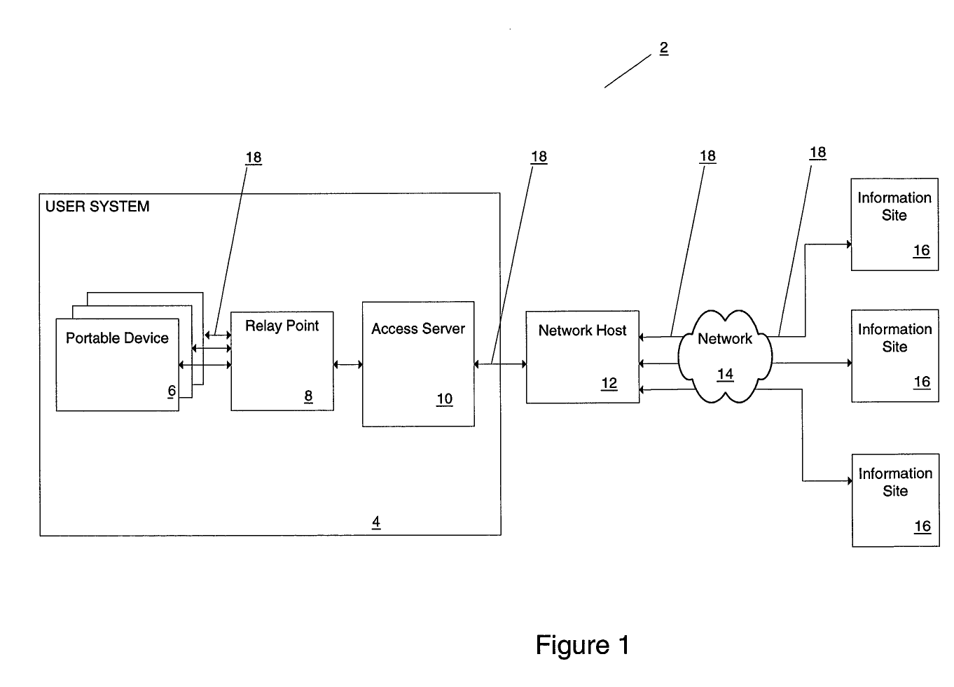

FIG. 1 illustrates an exemplary embodiment of an integrated health information system 2 having various segments along a network pathway. The network pathway 18 is an open network channel that provides a constant connection for the segments of the pathway so that data may continually flow through the segments. A user system 4 communicates with one or more remote sites 16 through an external network 14 and along the network pathway 18, according to the present invention. Within the user system 4, at least one portable healthcare device 6 is to communicate with an access server 10 often through one or more relay points 8 along the network pathway 18. Also, a network hub 12 in the network pathway 18 provides a connection from the user system to the external network 14.

Although FIG. 1 demonstrates a particular layout of integrated health information system, the scope of the present invention also anticipates other variations of the system to control information retrieval. Any number of portable healthcare devices may request health information from any number of remotes sites through any number of relay points, including no relay points, leading to one or more access servers, which may be arranged in various fashions within the network environment. In one embodiment, the access server and/or network hub may also be shared by various other user systems. In still other embodiments, no network hub is employed and the access server directly links to the network.

The user system 4 includes at least a wireless internal network for the user or a group of users. The user system may incorporate a wireless local area network (LAN) through which the components communicate. The user system may also include a wired internal network that communicates with the wireless internal network.

Through the wireless link within the user system, the portable healthcare device 6 provides for transmission and optionally also receipt of information. A health professional may use the portable healthcare device during the course of performing other daily tasks, such as caring for a patient, and simultaneously ask for and obtain health information “on the fly”. The portable healthcare device conveniently connects a health professional to sources outside of the user system, e.g. a remote site, in real-time and with minimal interruption to the professional.

The portable healthcare device 6 may include a variety of devices that are easily moveable or mobile and that may submit health information requests for receipt and processing by an access server. The portable healthcare device is usually a handheld computer that is of sufficient size to be used while a person is carrying it and often to be conveniently stored in a pocket. However, in some cases the portable healthcare device may also be temporarily converted from a transportable apparatus to a fixed unit, i.e. not easily movable, and which may have a wired connection to another computer system, when desired.

The portable healthcare device is an intelligent wireless device, such as a personal digital assistant (PDA), e.g. the iPAQ® Pocket PC (from Compaq Computer Corporation, located in Houston, Tex.) and Jomada® (from Hewlett-Packard Corporation, located in Palo Alto, Calif.); a wireless telephone (e.g. cellular, personal communications services (PCS), etc.), a wearable computer, a pager, a BlackBerry™ (from Research in Motion, Ltd., located in Ontario, Canada) or other wireless intelligent device that is portable and may additionally have specific components for use in the integrated health information system. The device may be a wireless, portable computer system, such as a laptop, pocket computer, etc., e.g. a personal computer (PC), such as a Macintosh® (from Apple Corporation of Cupertino, Calif.), Windows®-based PC (from Microsoft Corporation of Redmond, Wash.), or one of a wide variety of hardware platforms that runs the Microsoft's Pocket PC (from Microsoft), UNIX@, Sting or Linux® operating systems or other operating systems. The devices listed are by way of example and are not intended to limit the choice of apparatuses that are or may become available in the portable wireless communications device field that may send requests and optionally receive information without the need for wires or cables to transmit information, as described herein.

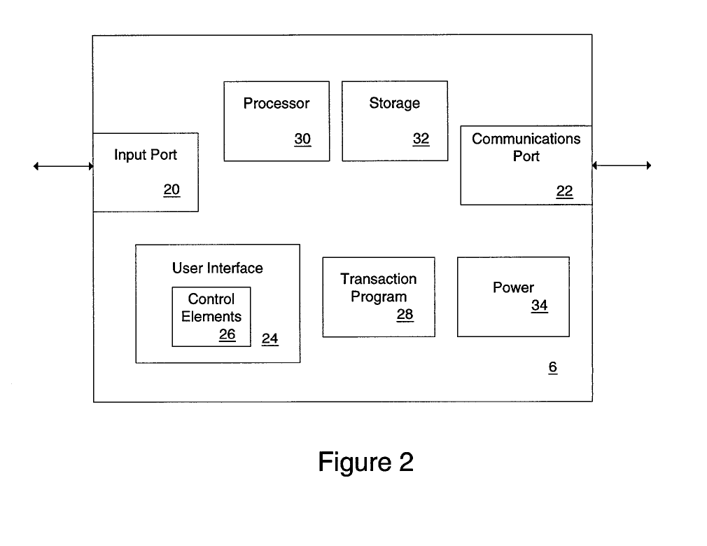

FIG. 2 depicts one embodiment of a portable healthcare device 6 having an input unit 20 to enter a request that is to be sent to an access server and a communication port 22 to forward data to and receive data from components of the user system, e.g. the access server, relay point(s) and/or other components along the network pathway.

A user interface 24 may be an audio, visual and/or kinesthetic, i.e. contact sensitive, interface that may include one or more control elements 26 to permit a user of the portable healthcare device to specify particular health information, input data such as consents, request-related data, etc. and to direct the portable healthcare device to create a request for that information. The user interface 24 is coupled to the input port 20 for instructions communicated through the user interface to enter the portable healthcare device.

There are various types of control elements that may be include in the user interface. One type of control element is visible through an optional display screen (e.g. a liquid crystal display) that may be integrated with the portable healthcare device or coupled to the device. Such control elements may include buttons, pop-up or pull-down menus, scroll bars, iconic images, and text entry fields. The visual control elements may be activated by a variety of mechanisms, such as a touch pad screen, pen-to-text data entry device, or activation mechanisms present on input/output devices, such as a keyboard and/or a mouse. Other control elements may be invisible to a display, such as voice or audio recognition elements, optical recognition elements, touch responsive elements, etc. There are a variety of interactive mechanisms to activate invisible and/or visible controls, such as voice or audio commands, touch movement or imprints, network signals, satellite transmissions, preprogrammed triggers within the system, instructional input from other applications, etc. All of the control elements described herein are by way of example and are not intended to limit the choices that are or may become available in the art.

One or more health transaction software program(s) 28 may provide prompts for the user to input desired transaction parameters through the user interface. For example, the transaction program may provide a list of types of health information for the user to request. The transaction program may also provide prompts for the user to submit patient information related to particular health information requested. The portable healthcare device may deliver numerous health-related transactions through various software packages, such as TouchWorks (from Allscripts Healthcare Solutions, located in Illinois).

The wireless communication port 22 sends data, such as requests for health information, request-related data and optionally consents, into the wireless portion of the network pathway to be passed through at least one relay point which in turn, transmits the request to the internal network for receipt at the access server.

The network pathway extending from the wireless communication port 22 of the portable healthcare device to the next receiving point in the pathway is a wireless communication channel. The wireless communication port 22 may communicate through electromagnetic transmissions, such as infrared radiation and radio frequency (RF), usually according to any of the numerous communication standards used in the telecommunication industry. A common standard protocol is IEEE 802.11b (published by IEEE, 1999), WiFi™, Bluetooth, etc. In addition, various protocols may be used by the portable healthcare device to communicate within the user system, such as a network layer (Open Systems Interconnection (OS) standards established by the International Standards Organization (ISO).

The portable healthcare device 6 also includes processor 30, which may represent one or more processors to run an operating system and applications software that controls the operation of other device components. Some exemplary processors are an Intel Pentium® (or x86) processor, a Motorola® Power PC processor, etc. The processor 30 may also be a microprocessor. The processor may be configured to perform multitasking of several processes at the same time.

A bus (not shown) may also be provided to carry information between portable healthcare device components. The width of the bus determines how much data can be sent between components, such as 8-bit, 16 bit 32 bit, 64 bit (e.g. Peripheral Component Interconnect (PCI) bus), etc. However, in some variations of portable healthcare device, particular components may couple directly to each other or through a dedicated bus for the particular components, rather than connecting through a general bus.

A storage unit 32 is provided to hold data related to a request, one or more option menu(s) for display to the user through the user interface, consent data, health information and/or other transaction-related data. The storage unit 32 may be any magnetic, optical, magneto-optical, tape, and/or other type of machine-readable medium or device for writing and storing data. For example, the storage unit 32 may be a writeable optical compact disc (e.g. CD ROM, DVD), a disc, tape, random access memory (RAM), such as dynamic RAM (DRAM) and static Ram (SRAM), etc. The amount of storage required depends on the type and amount of data stored.

Often a non-volatile storage, e.g. electrically erasable program read only memory (EEPROM), Flash memory, or cache, is provided for the operating system and resident software applications. The storage unit may also be a hard drive, either integrated within the system, or external and coupled to the system. The storage unit may also be coupled to other types of multiple storage areas that may be considered as part of the storage unit or separate from the storage unit. These storage units 32 described are by way of example and are not intended to limit the choice of storage that are or may become available in the data storage field, as described herein.

A power unit 34 is included with the portable healthcare device to supply energy used to operate the device components. In one embodiment, the power unit 34 may be an energy storage area to hold power, which may be integrated into the device, or able to be removable and capable of being inserted into the device. For example, the power unit 34 may be a battery that is charged by energy from an external source. In another embodiment, the power unit 34 may be simply a power connector to couple with and direct energy from an external power source to the various device components rather than to store energy.

Furthermore, the portable healthcare device may also have various optional components, such as security measures to ensure permitted access to the internal network, protect transferred data, and the like. Security may be provided through encryption and/or authorization tools. Another optional component includes one or more biometric authentication element to confirm authorized users of the portable healthcare device.

The transmission exiting from the portable healthcare device may pass through one or more relay points(s) 8, e.g. LAN access point(s), that serve as a bridge between the access server and/or an existing wired network and the wireless device. The relay point may also act as a repeater to pass along transmissions from one relay point to another. The relay point may be placed within the performance distance for transmission to form an interconnected transmission pathway. One such relay point is Intel PRO/Wireless 2011 LAN Access Point (by Intel Corporation, located in Santa Clara, Calif.).

Furthermore, in one embodiment of integrated health information system, a controller having intelligence may be provided within the user system to control the relay points. For example, the controller may manipulate the speed, direction, and/or amount of traffic through the relay points.

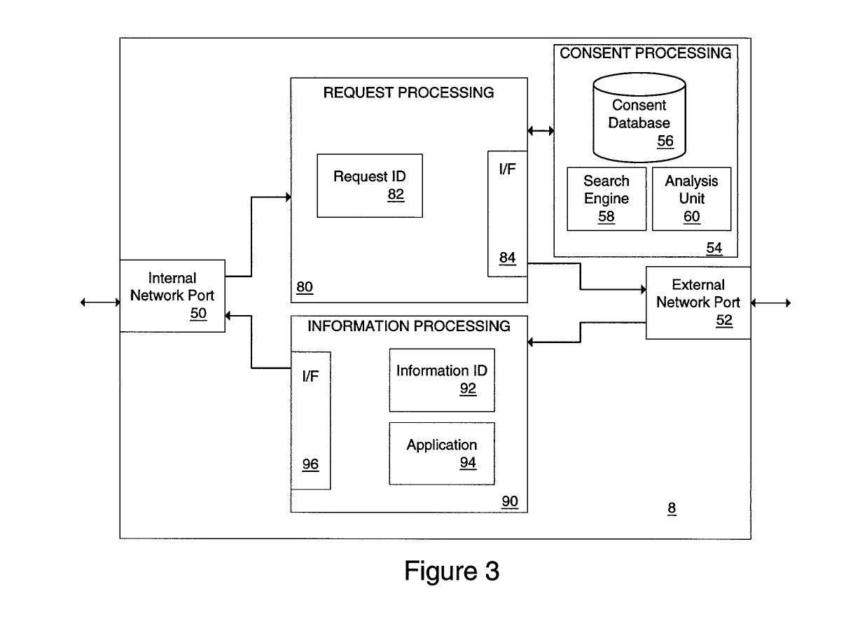

The access server 10 receives requests for health information from the portable healthcare device, usually through at least one relay point, and processes the request. The access server determines if a user is allowed to receive the information. One embodiment of access server having components to track and search for stored consent as shown, for example, in the one embodiment in FIG. 3. An internal network port 50 receives communication, e.g. requests promulgated from the portable healthcare device, of the internal network of the user system. Furthermore, the access server has an external network port 52 to transport and accept communications with a remote site, such as through a network host.

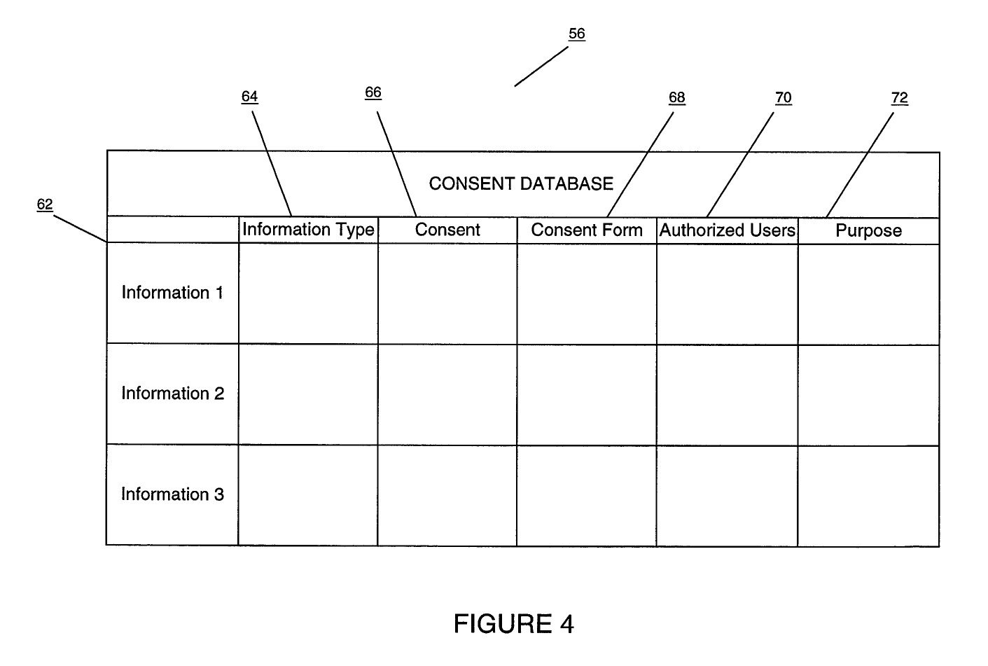

The access server also has various consent processing components 54 for handling consents provided to permit information retrieval. A consent database 56 stores an organized collection of consent data related to health information. Usually the consent database is found within or coupled to the access server. However, in other embodiments, the consent database is located at other locations and is queried by the access server. The access server 10 may have a search engine 58 to peruse consent database for specific data. One example of a consent database 56 is shown in FIG. 4 having consent data for information stored in a remote site. The various fields for consent data may vary, depending, inter alia, on the requirements for the health information release.

Each information item 62 refers to a body of health information located on the external network. Typically the information item is a reference to health information stored at the remote site or elsewhere and available to the remote site. Any number of information items may be listed in the consent database.

The consent database often has a type field 64 to specify a category of health information that may be transmitted in the network. The health information, for example, may comprise medical records, e.g. test results, prescriptions, etc; procedures a subject participated in; patient demographics; and the like; or combinations thereof. It will be apparent to one of ordinary skill in the art that other types of health information may be equivalently supported.

The consent database also provides a consent field 66 to indicate whether consent has been provided. The consent may be granted by any authorization holder, i.e. a person or entity permitted to provide binding consent to release the health information, consistent with applicable law, regulation, policy, or the like. Oftentimes, the subject of the health information is the authorization holder. However, at times, a legal representative, guardian, parent, person acting in loco parentis, etc. may provide consent to the extent that applicable law permits. With respect to deceased subjects, executors, administrators or other persons authorized under applicable law may act on behalf of the decedent's estate in providing consent. In addition, in some cases, the subject of the health information may appoint an authorization holder to provide the consent, e.g. if the subject is incapacitated, unable or otherwise unavailable to provide the consent.

The consent field 66 may have data that specifies whether the consent has been received or not. In some embodiments, the consent data also suggests whether a received consent is current or expired. In still other cases, the consent data includes the date in which the consent was authorized by a subject.

In some cases, a form field 68 is provided to store various formats in which consent was given by the authorization holder. Some forms for the consent include a writing signed by the subject, an electronic signature, a verbal consent, etc.

The database may include a user field 70 to specify an authorized user who is permitted, through corresponding consent, to receive a particular body of information. The user field may list an individual, group, entity, or the like. In some cases, the authorized user is the individual or entity that is the subject of the health information, e.g. patient. In this instance, the access server may determine that no consent is required and automatically permit the subject access to the requested health information. Such permitted access to the health records by the subject may comply with certain government regulations, e.g. 45 CFR Parts 160 through 164, id.

At times, the intended use for the health information is another element that may be considered in determining the appropriateness of the consent, the requirements for a consent, etc. A purpose field 72 may be provided in the consent database to specify the intended reasons for which health information may be accessed, according to the associated consent. Some exemplary purposes for retrieving the health information may include providing care, teaching, training, conducting research, ensuring quality, etc. Furthermore, a particular type of consent may be required for certain access purposes. For example, where the intended reason for wanting the health information is to decide on employment-related choices for a subject, specific informed permission from the subject may be required. Another objective in obtaining health information may be to protect public welfare, such as to address outbreak of an infectious disease.

Still other data fields may be include in certain embodiments of consent database to store data that may be useful in determining whether particular information may be provided. For example, data fields may specify the appropriateness of a particular consent, whether a consent is required for a body of health information, etc.

In one embodiment, further distinctions are made based on the source of the information related to a patient. For example, patient/health information may be provided by a particular physician, physician's office, hospital, clinic, laboratory, etc. These information sources can be retained and used to further qualify the consent or access given for particular patient/health information content.

In addition to the consent database, the access server 10 may include one or more consent analysis unit 60 to determine the suitability of a consent. Thus, once a consent is located by the search engine, the analysis unit 60 inspects the consent and concludes whether the consent satisfies requirements for release of the health information. In one example, the analysis unit retrieves consent data including the date in which the consent was executed. The analysis unit may determine whether the consent has expired or whether it is still current.

An optional component of the access server for handling consents is an access log, which permits tracking of persons and/or groups who have accessed the specific health information. For example, a patient may be permitted to know who has retrieved its personal health records.

Another alternative consent-related component is a filtering component, which may restrict disclosure of health information to the minimum extent needed for an intended purpose. The access server may receive a request for a general body of health information and determine the specific portions of health information permitted to be sent to the user, consistent with the particular purpose of the request. In one embodiment, a request for only the necessary information is forwarded to the remote site. Thus, in this case, the request is altered prior to sending the payload data into the network. In the alternative, the request payload data may be unaltered and forwarded, but the returned health information may be screened, such that only particular types of information is sent to the user.

In addition to consent components, the access server has request processing components 80 for processing a request received from the user system and transferring the request to be received by the remote information site. A request identification unit 82 determines the appropriate remote site to receive the request. Furthermore, a server interface 96 prepares the request to be in a suitable format for the next segment of the network pathway to receive the request.

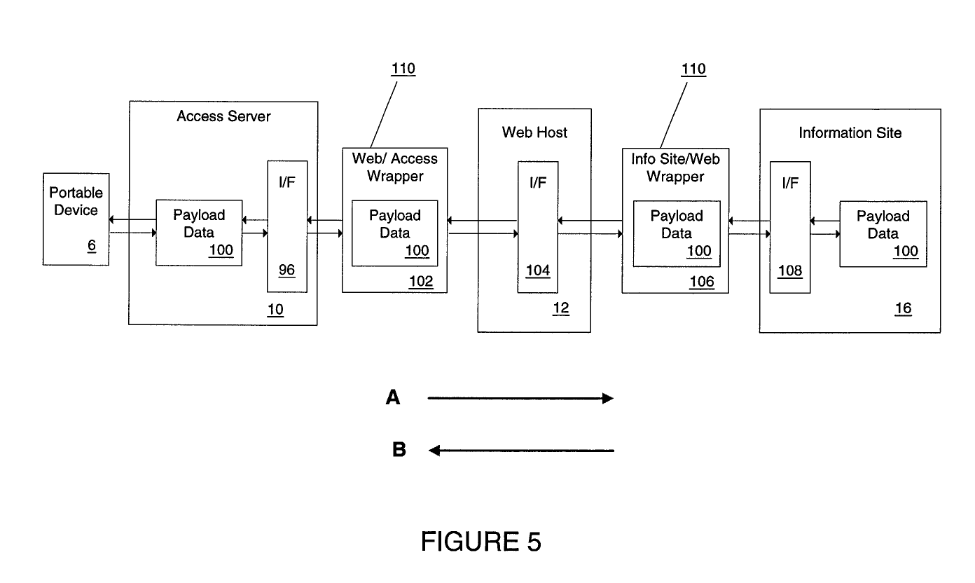

As shown in the exemplary information transfer process in FIG. 5, the various interfaces in the integrated health information system provide the capability for disparate systems to communicate with each other and provide a real-time channel for information to flow between the user system and remote information site. The request that is sent from the user system starts as a payload data 100 and flows through a server interface 96. The server interface 96 places the payload data 100 in a wrapper 102 that contains the header information recognizable by the next segment in the network pathway towards the remote site, e.g. the network host 12, remote site, etc. The server interface usually does not alter the request data as generated from the portable healthcare device.

The access server also has various components to process health information received from the remote information site and to pass the information to the appropriate user in the user system 90. The access server may have an information identification unit 92 to determine what type of information is received. This information identification unit may recognize the received information as a response to an earlier requested transaction or as a new transaction. Thus, the access server may maintain a log of references to requested transactions and the identification unit compares the incoming information with the references in the log. Accordingly, the identification unit may determine where the information should be transferred to as provided by the original request, such as the requesting portable healthcare device, some other portable healthcare device, a designated electronic device or computer, etc. Thus, at times, some other user, in addition to, or in place of the requesting portable healthcare device, may retrieve the health information.

Furthermore, an application unit 94 may be in the access server to determine what software application program the information belongs to and how to enter the information into the appropriate application. The information may be associated with an application that is specific for the remote information site that sent it or multiple remote sites may be supported by one application program. In addition, a storage verification unit may be provided to ascertain whether the access server is to store the health information. Such storing of health information may be made in addition to transferring the information to a user, or in lieu of such transfer.

As shown in FIG. 5, the server interface 96 prepares payload data 100 received from a remote information site for receipt at the next segment in the network pathway towards the intended user, according to the original request. Often, the preparation includes the server interface 96 removing the wrapper 102 from the received information to reveal the payload data 100.

The access server usually also includes basic server components, such as a processor for controlling the other server components, and a storage unit for storing programs, data, bus(es), etc.

In still other embodiments of an access server, various other optional components may be present in the access server that assist in controlling retrieval of health information. An authentication database may be provided for maintaining data to verify a person's identity. For example, the database, such as the consent database, may contain biometric authentication data, credentialing data, etc., which is associated with an authorization holder and/or an authorized user that may access particular health information.

Another optional access server component is a speech recognition engine may be included to convert speech data collected by the portable healthcare device. The access server may include components to vary and control the speed of network traffic, protocols based on the amount of noise in the network, encryption protocols, etc.

The user system is coupled to a network host 12 in order for the user system to maintain a connection with a network to the remote site. As shown in FIG. 5, the network host 12 has a host interface 104 that prepares the payload data, e.g. request, for reading by a remote information site and sends the request into the network 14. Usually, the host interface envelopes the request data with a remote information site wrapper 106 having data, e.g. header information, acceptable by the remote site, which is the ultimate destination. The host interface may remove any present wrappers 102 and provide a new wrapper 106 specific for the remote site to receive the request data. Oftentimes, each remote site requires different wrapper information.

Furthermore, the interface that information received from the external network, e.g. a remote site, for reading by the access server. Any prior wrapper of the information may be removed and the information re-wrapped with wrapper data 102 appropriate for the access server.

The network 14 is a public network (e.g. the Internet), semi-public network that provides for tunneling of data packets (e.g. a virtual private network (VPN)), or private (e.g. dedicated leased communication line, which may only be used by one user system and remote site) network. Usually, the network provides for security in transport, as in a VPN where special encryption is used at the sending end and decryption at the receiving end.

One or more remote information site 16 retains health information or has ready access to health information stored elsewhere, and communicate with various components of the user system from across the respective network pathway. The remote information site is capable of providing responses to requests in real-time through the integrated health information system of the present invention. The remote sites may be any entity that possesses protected health information and quickly transmits the health information in electronic form in connection with requests from a user. The remote site has the requested information readily available or may create the information immediately upon receiving the request.

Usually the remote site is an application service provider (ASP) or similar backend service center that collects data, acts upon the data and sends the data to a user system. The remote site may be a healthcare clearinghouse that processes or facilitates the processing of data elements of health information. A health planner may also serve as a remote site that provides, or pays the cost of, medical care, e.g. through an individual plan or group health plan. The information site may be a PBM, prescription service, prescription refill service, testing lab, transcription company, etc. For example, a PBM may have certain health information for use in determining whether an insurance plan or HMO should cover a prescription.

The health information that is directed through the integrated health information system by the remote information site starts out as a payload data, as shown in FIG. 5, a remote site interface 108 removes the wrapper 106 to reveal the payload data 100, e.g. request, received from the network. The remote site interface 106 also prepares payload data 100, e.g. health information, for sending into the network by placing the payload data into a wrapper 106 for web host access.

Further to the various segments of an integrated health information system 2, other optional segments may be included to perform various additional features of a system. For example, the user system 4 may include a support computer to communicate with the portable healthcare device; perform tasks initiated at the portable healthcare device; store data; communicate with the internal wireless network, etc. The support computer may include a “back-end” program that supports a “front-end” program running on the portable healthcare device. The support computer may perform any necessary processing and translation of the data being communicated to and from the portable healthcare device and the network. At times, the functions of the support computer are combined into the access server of the user system, rather than employing a separate support computer.

In some embodiments of health information system, a receiving device may also be included in the network pathway to receive the health information that is requested by the portable healthcare device. In this embodiment, the health information sent from a remote site may be sent to the portable healthcare device and/or another receiving device. This optional receiving device may be a support computer a portable healthcare device other than the requesting portable healthcare device, or other segment of the health information system. In this instance, the request for health information from the portable healthcare device also includes a reference to a receiving device that is to obtain the health information. Thus, the portable healthcare device that requests the information may not be the same device that receives the information. The access server may further consider whether consent is required and/or provided for such a receiving device to accept the information.

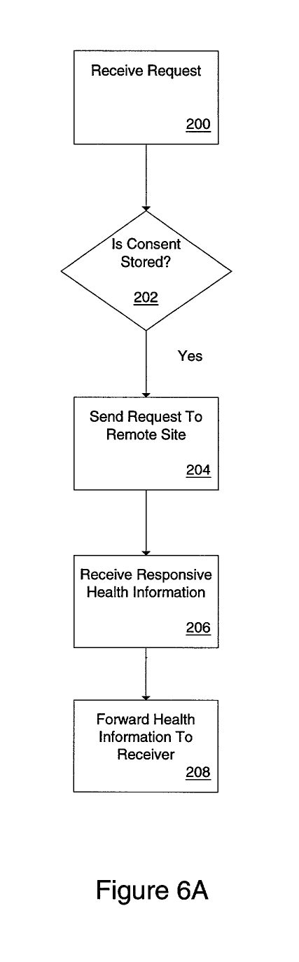

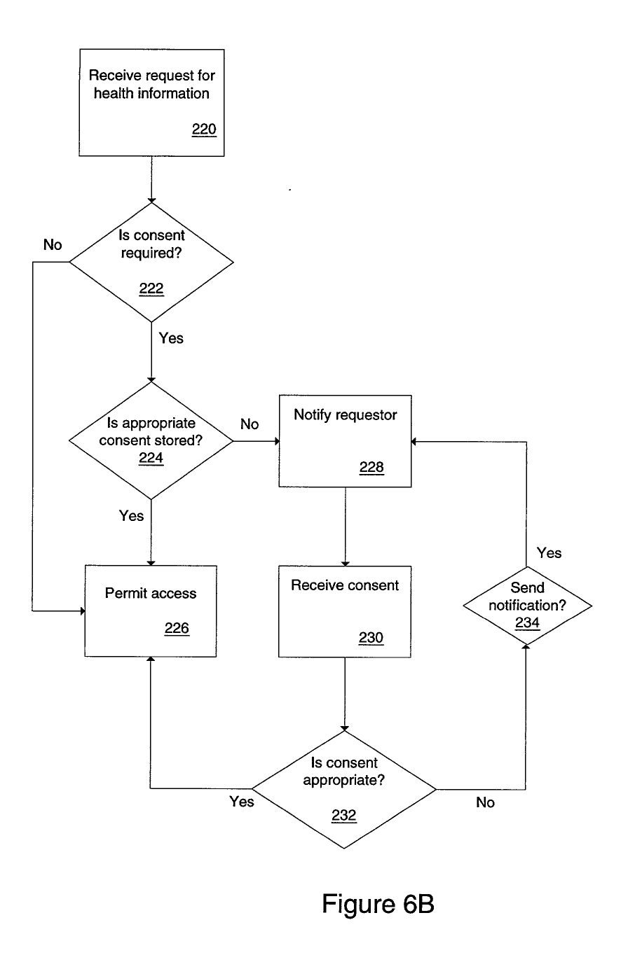

FIG. 6A shows one embodiment of the health information retrieval process as performed by an access server, according to the present invention. The server receives a request for health information from the portable healthcare device 200. From the time the portable healthcare device submits the request, the required data swiftly flows through all segments of the network pathway and all steps of the process are instantly performed to achieve seemingly real-time retrieval of information where a corresponding consent had been previously provided. The request arrives from across an internal network and the access server immediately processes the request by determining if a corresponding consent is stored 202. If the corresponding consent is stored, the server immediately sends the request across the external network to a remote site 204. At once, the remote site responds and the server immediately receives the health information from the remote site 206, responsive to the request. As soon as the information is received, it is forwarded back across the internal network to the intended user 208, e.g. to the portable healthcare device, as specified in the original request.

In some embodiments, the access server may also determine if consent is required for the transaction and/or provide notice to the portable healthcare device. One such process is depicted in the flowchart in FIG. 6b. For example, the access server receives a request that particular health information be delivered to a specific user 220. The access server may assess whether consent is required 222, e.g. whether constraints are attached to the requested health information, to the user wanting access to the information and/or to the intended purpose for receiving the information. If there is no requirement for such consent, the access server may automatically permit the user to receive the information 226. The access server searches for a corresponding consent from storage 224.

In some embodiments where consent is required but not located in storage, the access server may send a notice of this deficiency to the portable healthcare device that initiated the request 228. The user may opt to obtain consent from the authorization holder and transfer it to the access server. Where the request for information occurs at the point of care, such consent may be gained immediately by the patient and relayed to the access server. The consent may be of various formats. The newly acquired corresponding consent may be fingerprint data, retinal data, voice data, or a digital signature data and further including comparing the corresponding consent with stored consent data. The access server receives the newly acquired consent 230 and may store the consent. The access server may also optionally also send the consent to any appropriate party that should require it. Furthermore, the access server may examine the newly acquired consent to determine if the consent is appropriate for the request 232. If the consent is not satisfactory to permit the intended user to access the health information, the access server may opt to notify the portable healthcare device of the further deficiency 234, which device may attempt to get the consent again or correct the deficiency. Where the newly acquired consent is appropriate, the access server may permit access to the health information by forwarding the request to the remote site 226.

In one embodiment of portable healthcare device, the consent is provided or supported through an authentication measure, e.g. by human measurement, such as fingerprinting, handwriting analysis, retinal scanning, hand geometry, voice printing, or other biometric authentication means, is used to verify consent is from the authorization holder.

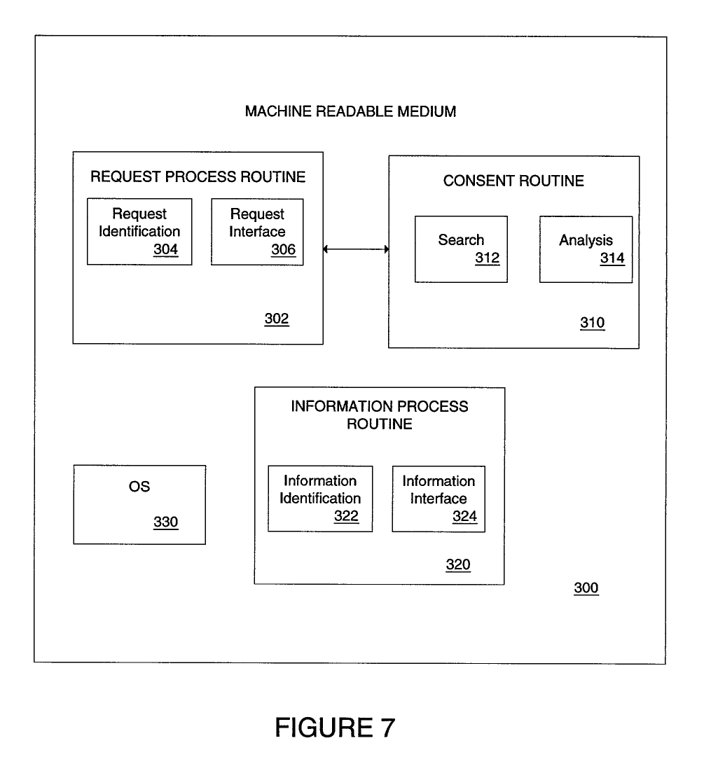

Various software components, e.g. applications programs, may be provided within or in communication with the access server that cause the processor or other components of the server to execute the numerous methods employed in controlling access to health information from across a network. FIG. 7 is a block diagram of a machine-accessible medium storing executable code and/or other data to provide one or a combination of mechanisms for permitting health information having proper consent to be sent from a remote site across a network to a user, according to one embodiment of the invention.

The machine-accessible storage medium 300 represents one or a combination of various types of media/devices for storing machine-readable data, which may include machine-executable code or routines. As such, the machine-readable storage medium 300 could include, but is not limited to one or a combination of a magnetic storage space, magneto-optical storage, tape, optical storage, battery backed dynamic random access memory, battery backed static RAM, flash memory, etc. Various subroutines may also be provided. These subroutines may be parts of main routines in the form of static libraries, dynamic libraries, system device drivers or system services. The processes of various subroutines, which when executed, are described above with regard to FIG. 6A.

The machine-readable storage medium 300 is shown having request processing routine 302, which, when executed, processes a request for the health information received from a portable healthcare device across an internal network, through various subroutines. A request identification subroutine 304 is for determining the appropriate remote site to receive the request. A request interface subroutine 306 is for preparing the request to be in a suitable format for the particular remote information site receiving the request and transporting the request into an external network to be obtained by the remote site.

The machine-readable storage medium 300 also has a consent routine 310 that is for determining if a corresponding consent has been provided. A search subroutine 312 looks for a stored consent that matches the request data. An analysis subroutine 314 may be provided to determine the suitability of a consent by referencing other consent data.

The machine-readable storage medium 300 also is depicted as having a processing health information routine 320 that processes health information received in response to a request forwarded to a remote site, where a corresponding consent had been found. An information identification subroutine 322 is provided to determine the type of health information that is received. In addition, a health information interface subroutine 324 is for preparing the request to be in a suitable format for the particular remote information site receiving the request and forwarding the health information back across the internal network

In addition, other software components may be included, such as an operating system 330.

The software components may be provided in as a series of computer readable instructions that may be embodied as data signals in a carrier wave. When the instructions are executed, they cause a processor to perform the monitoring of consent steps as described. For example, the instructions may cause a processor to assess a request, check for a corresponding consent, and permit access to the requested health information, etc. Such instructions may be presented to the processor by various mechanisms, such as a plug-in, static library, dynamic library, system device driver, system service, etc.

The present invention has been described above in varied detail by reference to particular embodiments and figures. However, these specifics should not be construed as limitations on the scope of the invention, but merely as illustrations of some of the presently preferred embodiments. It is to be further understood that other modifications or substitutions may be made to the described integrated health information system as well as methods of its use without departing from the broad scope of the invention. The above-described steps of controlling access to health information through a real-time network pathway may be performed in various orders. Therefore, the following claims and their legal equivalents should determine the scope of the invention.

What is claimed is:

1. A method of controlling transfer of health information along a network pathway, the method comprising:
receiving a request for the health information from across an internal network, the request being generated from a portable healthcare device;
immediately determining if a corresponding consent is stored; and
if the corresponding consent is stored, permitting the health information to be immediately acquired by sending the request across an external network to be obtained by a remote site, receiving the health information from the remote site, and forwarding the health information back across the internal network.

2. The method of claim 1, wherein the forwarding of the health information is to the portable healthcare device.

3. The method of claim 1, wherein if no corresponding consent is stored, further including sending a notice to the portable healthcare device.

4. The method of claim 3, further including receiving the appropriate consent from the portable healthcare device and permitting the health information to be immediately acquired by sending the request across an external network to a remote site, receiving the health information from the remote site, and forwarding the health information back across the internal network

5. The method of claim 4, wherein the corresponding consent is fingerprint data, retinal data, voice data, or a digital signature data and further including comparing the corresponding consent with stored consent data.

6. The method of claim 1, further including determining if consent is required prior to the determining if a corresponding consent is stored, and if the consent is not required, permitting the health information to be immediately acquired by sending the request across an external network to a remote site, receiving the health information from the remote site, and forwarding the health information back across the internal network.

7. The method of claim 1, wherein the remote site is a pharmacy benefit manager.

8. The method of claim 1, further including determining the suitability of a corresponding consent.

9. The method of claim 1, further including placing the request in a wrapper for acceptance by a next segment in the network pathway towards the remote site.

10. The method of claim 9, further including unwrapping health information received from across and external network.

11. A health information access server, comprising:
a) an internal network port to receive a request for health information from a portable healthcare device for a user;
b) a consent database to store consents corresponding to health information;
c) a search engine to determine if a corresponding consent is stored in the database for requested health information; and
d) a server interface to prepare the request for receipt by a next segment in the network pathway towards a remote site, and to prepare the health information sent in response from the remote site to be received by a next segment in the network pathway towards the user.

12. The information access server of claim 11, further including a consent analysis unit to determine the suitability of a corresponding consent.

13. The information access server of claim 11, further including a request identification unit to determine the appropriate remote site to receive the request.

14. The information access server of claim 111, further including a health information identification unit to determine what type of information is received.

15. The information access server of claim 11, further including an application unit to determine an appropriate software application program for the health information to be entered into.

16. A computer accessible medium having stored therein a plurality of sequences of executable instructions, which, when executed by a processor, cause the system to:
process a request for the health information received from across an internal network, the request being generated from a portable healthcare device;
immediately determine if an corresponding consent is stored; and
if the corresponding consent is stored, permit the health information to be immediately acquired by sending the request across an external network to a remote site, receiving the health information from the remote site, and forwarding the health information back across the internal network.

17. The computer accessible medium of claim 16, wherein the forwarding of the health information is to the portable healthcare device.

18. The computer accessible medium of claim 16, if no corresponding consent is stored, further including additional sequences of executable instructions, which, when executed by the processor further cause the system to send a notice to the portable healthcare device.

19. The computer accessible medium of claim 18, if no corresponding consent is stored, further including additional sequences of executable instructions, which, when executed by the processor further cause the system to receive the appropriate consent from the portable healthcare device and to permit the health information to be immediately acquired by sending the request across an external network to a remote site, receiving the health information from the remote site, and forwarding the health information back across the internal network.

20. The computer accessible medium of claim 19, wherein the corresponding consent is fingerprint data, retinal data, voice data, or a digital signature data and further including comparing the corresponding consent with stored consent data

21. The computer accessible medium of claim 16, further including additional sequences of executable instructions, which, when executed by the processor further cause the system to determine if consent is required and if the consent is not required, to permit the health information to be immediately acquired by sending the request across an external network to a remote site, receiving the health information from the remote site, and forwarding the health information back across the internal network.

22. The computer accessible medium of claim 16, further including additional sequences of executable instructions, which, when executed by the processor further cause the system determine the suitability of a corresponding consent.

23. The computer accessible medium of claim 16, further including additional sequences of executable instructions, which, when executed by the processor further cause the system to placing the request in a wrapper for acceptance by a next segment in the network pathway towards the remote site.

24. The computer accessible medium of claim 23, further including additional sequences of executable instructions, which, when executed by the processor further cause the system to interrupt a processor to unwrap health information received from across and external network.

25. A method of controlling transfer of health information along a network pathway, the method comprising:
receiving a request for the health information from across an internal network, the request being generated from a portable healthcare device;
immediately determining if a corresponding consent is stored;
if the corresponding consent is stored, permitting the health information to be immediately acquired by sending the request across an external network to be obtained by a remote site, receiving the health information from the remote site, and forwarding the health information to the portable healthcare device; and
if no corresponding consent is stored, further including sending a notice to the portable healthcare device.

26. The method of claim 25, further including receiving the appropriate consent from the portable healthcare device and permitting the health information to be immediately acquired by sending the request across an external network to a remote site, receiving the health information from the remote site, and forwarding the health information back across the internal network.

27. The method of claim 25, wherein the corresponding consent is fingerprint data, retinal data, voice data, or a digital signature data and further including comparing the corresponding consent with stored consent data.
